(19) United States
(12) Patent Application Publication
(10) Pub. No.: US 2024/0265337 A1
(43) Pub. Date: Aug. 8, 2024

(54) METHOD EXECUTED BY INFORMATION PROCESSING DEVICE, NON-TRANSITORY COMPUTER-READABLE MEDIUM, AND INFORMATION PROCESSING DEVICE

(71) Applicant: Toyota Jidosha Kabushiki Kaisha, Toyota-shi (JP)

(72) Inventors: Hiroto Tomida, Tokyo (JP); Jean-Sebastien Boire, Yokohama-shi (JP); Motohiro Nakamura, Okazaki-shi (JP)

(73) Assignee: Toyota Jidosha Kabushiki Kaisha, Toyota-shi (JP)

(21) Appl. No.: 18/430,822

(22) Filed: Feb. 2, 2024

(30) Foreign Application Priority Data
Feb. 6, 2023 (JP) 2023-016470

(51) Int. Cl. G06Q 10/0834; G06Q 10/0631

(52) U.S. Cl. CPC G06Q 10/0834; G06Q 10/063118

(57) ABSTRACT

A method executed by an information processing device includes: setting a priority degree of each berth for each delivery person based on first information indicating a position of a storage location for parcels and second information indicating a position of each berth; specifying a work time slot for a first delivery person; and executing an allocation process. The allocation process includes: determining whether a condition is met; allocating a berth to the first delivery person when it is determined that the condition is not met; determining whether to execute re-allocation when it is determined that the condition is met; and canceling allocation of a berth to a second delivery person and allocating the berth to the first delivery person when it is determined to execute re-allocation. The information processing device repeatedly executes the allocation process while changing a first berth until a berth is allocated to the first delivery person.

### CROSS-REFERENCE TO RELATED APPLICATION

This application claims priority to Japanese Patent Application No. 2023-016470 filed on Feb. 6, 2023 incorporated herein by reference in its entirety.

### BACKGROUND

### 1. Technical Field

The present disclosure relates to a method executed by an information processing device, a non-transitory computer-readable medium, and an information processing device.

### 2. Description of Related Art

There has hitherto been known a technology of notifying a driver (hereinafter also referred to as a “delivery person”) that performs the work of loading parcels from a warehouse onto a truck of a berth allocated in advance. Japanese Unexamined Patent Application Publication No. 2004-13754 (JP 2004-13754 A), for example, discloses a technology of notifying a driver of an allocated berth number based on a schedule and an expected arrival indicated by the driver.

### SUMMARY

There is room for improvement in the technology of allocating a berth in advance. For example, when two or more delivery persons to whom the same berth is allocated are to use the berth in overlapping time slots because of a certain factor such as work delay, leading to re-allocation of a different berth to one of the delivery persons, the work of loading parcels may thus be hindered, depending on the positional relationship with the storage location for parcels to be delivered by the one delivery person in a warehouse.

The present disclosure, which has been made in view of such circumstances, makes it possible to improve the technology of allocating a berth in advance.

A first aspect of the present disclosure provides a method executed by an information processing device that determines a berth to be allocated to a delivery person from among a plurality of berths provided in a warehouse, the method including: setting priority degrees of the berths for each of delivery persons, each of the priority degrees of the berths being set based on first information and second information, the first information indicating a position of a storage location in the warehouse for each of one or more parcels to be delivered by a corresponding one of the delivery persons, and the second information indicating a position of each of the berths in the warehouse; specifying a first work time slot in which a first delivery person to whom none of the berths has been allocated uses any one of the berths, the first delivery person being included in the delivery persons; and executing an allocation process. The allocation process includes selecting a first berth as a candidate to be allocated to the first delivery person, from among the berths, based on a priority degree of each of the berths set for the first delivery person, determining whether a condition that a second delivery person has already been allocated to the first berth and the first work time slot for the first delivery person and a second work time slot for the second delivery person at least partially overlap each other is met, the second delivery person being included in the delivery persons, allocating the first berth to the first delivery person when it is determined that the condition is not met, making a comparison between a first priority degree and a second priority degree when it is determined that the condition is met, the first priority degree being a priority degree of the first berth set for the first delivery person, and the second priority degree being a priority degree of the first berth set for the second delivery person, and canceling allocation of the first berth to the second delivery person and allocating the first berth to the first delivery person when it is determined that the first priority degree is higher than the second priority degree. The information processing device repeatedly executes the allocation process while changing the first berth as a candidate to be allocated to the first delivery person until one of the berths is allocated to the first delivery person.

In the method according to the above aspect, the information processing device may set the priority degrees of the berths for each of the delivery persons based on the first information, the second information, and third information, the third information being information that indicates a parcel amount of the one or more parcels to be delivered by the corresponding one of delivery persons; and the allocation process may further include making a comparison between a first parcel amount and a second parcel amount when it is determined that the first priority degree is equal to the second priority degree, the first parcel amount being a parcel amount of one or more parcels to be delivered by the first delivery person, and the second parcel amount being a parcel amount of one or more parcels to be delivered by the second delivery person, and canceling the allocation of the first berth to the second delivery person and allocating the first berth to the first delivery person when it is determined that the first parcel amount is larger than the second parcel amount.

In the method according to the above aspect, in a case where parcels to be delivered by one delivery person included in the delivery persons are dispersedly stored at a plurality of storage locations, the information processing device may set a priority degree of a given berth for the one delivery person to be higher as a distance from a storage location at which a largest parcel amount of parcels is stored, among the storage locations, to the given berth is shorter when setting a priority degree of each of the berths for the one delivery person.

In the method according to the above aspect, in a case where parcels to be delivered by one delivery person included in the delivery persons are dispersedly stored at a plurality of storage locations, the information processing device may set a priority degree of a given berth for the one delivery person to be higher as a total value of distances from the storage locations for the parcels to be delivered by the one delivery person to the given berth is smaller when setting a priority degree of each of the berths for the one delivery person.

In the method according to the above aspect, in a case where parcels to be delivered by one delivery person included in the delivery persons are dispersedly stored at a plurality of storage locations, the information processing device may set a priority degree of a given berth for the one delivery person to be higher as a sum of values is smaller when setting a priority degree of each of the berths for the one delivery person, each of the values being obtained by multiplying a distance from one location included in the storage locations for the parcels to be delivered by the one delivery person to the given berth by a parcel amount of the one or more parcels that are stored at the one location.

The method according to the above aspect may further include correcting the first work time slot for the first delivery person when none of the berths is allocated to the first delivery person even if the allocation process is executed a predetermined number of times.

The method according to the above aspect may further include transmitting a result of executing the allocation process to a terminal device of the first delivery person and a terminal device of the second delivery person.

A second aspect of the present disclosure provides a non-transitory computer-readable medium storing a program causing an information processing device that determines a berth to be allocated to a delivery person from among a plurality of berths provided in a warehouse to execute processes including: setting priority degrees of the berths for each of delivery persons, each of the priority degrees of the berths being set based on first information and second information, the first information indicating a position of a storage location in the warehouse for each of one or more parcels to be delivered by a corresponding one of the delivery persons, and the second information indicating a position of each of the berths in the warehouse; specifying a first work time slot in which a first delivery person to whom none of the berths has been allocated uses any one of the berths, the first delivery person included in the delivery persons; and executing an allocation process. The allocation process includes selecting a first berth as a candidate to be allocated to the first delivery person, from among the berths, based on a priority degree of each of the berths set for the first delivery person, determining whether a condition that a second delivery person has already been allocated to the first berth and the first work time slot for the first delivery person and a second work time slot for the second delivery person at least partially overlap each other is met, the second delivery person being included in the delivery persons, allocating the first berth to the first delivery person when it is determined that the condition is not met, making a comparison between a first priority degree and a second priority degree when it is determined that the condition is met, the first priority degree being a priority degree of the first berth set for the first delivery person, and the second priority degree being a priority degree of the first berth set for the second delivery person, and canceling allocation of the first berth to the second delivery person and allocating the first berth to the first delivery person when it is determined that the first priority degree is higher than the second priority degree. The information processing device repeatedly executes the allocation process while changing the first berth as a candidate to be allocated to the first delivery person until one of the berths is allocated to the first delivery person.

In the non-transitory computer-readable medium according to the above aspect, the information processing device may set the priority degrees of the berths for each of the delivery persons based on the first information, the second information, and third information, the third information being information that indicates a parcel amount of the one or more parcels to be delivered by the corresponding one of the delivery persons; and the allocation process may further include making a comparison between a first parcel amount and a second parcel amount when it is determined that the first priority degree is equal to the second priority degree, the first parcel amount being a parcel amount of one or more parcels to be delivered by the first delivery person, and the second parcel amount being a parcel amount of one or more parcels to be delivered by the second delivery person, and canceling the allocation of the first berth to the second delivery person and allocating the first berth to the first delivery person when it is determined that the first parcel amount is larger than the second parcel amount.

In the non-transitory computer-readable medium according to the above aspect, when parcels to be delivered by one delivery person included in the delivery persons are dispersedly stored at a plurality of storage locations, the information processing device may set a priority degree of a given berth for the one delivery person to be higher as a distance from a storage location at which a largest parcel amount of parcels is stored, among the storage locations, to the given berth is shorter when setting a priority degree of each of the berths for the one delivery person.

In the non-transitory computer-readable medium according to the above aspect, in a case where parcels to be delivered by one delivery person included in the delivery persons are dispersedly stored at a plurality of storage locations, the information processing device may set a priority degree of a given berth for the one delivery person to be higher as a total value of distances from the storage locations for the parcels to be delivered by the one delivery person to the given berth is smaller when setting a priority degree of each of the berths for the one delivery person.

In the non-transitory computer-readable medium according to the above aspect, in a case where parcels to be delivered by one delivery person included in the delivery persons are dispersedly stored at a plurality of storage locations, the information processing device may set a priority degree of a given berth for the one delivery person to be higher as a sum of values is smaller when setting a priority degree of each of the berths for the one delivery person, each of the values being obtained by multiplying a distance from one location included in the storage locations for the parcels to be delivered by the one delivery person to the given berth by a parcel amount of the one or more parcels stored at the one location.

In the non-transitory computer-readable medium according to the above aspect, the information processing device may be further caused to correct the first work time slot for the first delivery person when none of the berths is allocated to the first delivery person even if the allocation process is executed a predetermined number of times.

In the non-transitory computer-readable medium according to the above aspect, the information processing device may be further caused to transmit a result of executing the allocation process to a terminal device of the first delivery person and a terminal device of the second delivery person.

A third aspect of the present disclosure provides an information processing device that determines a berth to be allocated to a delivery person from among a plurality of berths provided in a warehouse, including a control unit configured to: set priority degrees of the berths for each of delivery persons, each of the priority degrees of the berths being set based on first information and second information, the first information indicating a position of a storage location in the warehouse for each of one or more parcels to be delivered by a corresponding one of the delivery persons, and the second information indicating a position of each of the berths in the warehouse; specify a first work time slot in which a first delivery person to whom none of the berths has been allocated uses any one of the berths, the first delivery person being included in the delivery persons; and execute an allocation process. The allocation process includes selecting a first berth as a candidate to be allocated to the first delivery person, from among the berths, based on a priority degree of each of the berths set for the first delivery person, determining whether a condition that a second delivery person has already been allocated to the first berth and the first work time slot for the first delivery person and a second work time slot for the second delivery person at least partially overlap each other is met, the second delivery person being included in the delivery persons, allocating the first berth to the first delivery person when it is determined that the condition is not met, making a comparison between a first priority degree and a second priority degree when it is determined that the condition is met, the first priority degree being a priority degree of the first berth set for the first delivery person, and the second priority degree being a priority degree of the first berth set for the second delivery person, canceling allocation of the first berth to the second delivery person and allocating the first berth to the first delivery person when it is determined that the first priority degree is higher than the second priority degree, and repeatedly executing the allocation process while changing the first berth as a candidate to be allocated to the first delivery person until one of the berths is allocated to the first delivery person.

In the information processing device according to the above aspect, the control unit may set the priority degrees of the berths for each of the delivery persons based on the first information, the second information, and third information, the third information being information that indicates a parcel amount of the one or more parcels to be delivered by the corresponding one of the delivery persons; and the allocation process may further include making a comparison between a first parcel amount and a second parcel amount when it is determined that the first priority degree is equal to the second priority degree, the first parcel amount being a parcel amount of one or more parcels to be delivered by the first delivery person, and the second parcel amount being a parcel amount of one or more parcels to be delivered by the second delivery person, and canceling the allocation of the first berth to the second delivery person and allocating the first berth to the first delivery person when it is determined that the first parcel amount is larger than the second parcel amount.

In the information processing device according to the above aspect, in a case where parcels to be delivered by one delivery person included in the delivery persons are dispersedly stored at a plurality of storage locations, the control unit may set a priority degree of a given berth for the one delivery person to be higher as a distance from a storage location at which a largest parcel amount of parcels is stored, among the storage locations, to the given berth is shorter when setting a priority degree of each of the berths for the one delivery person.

In the information processing device according to the above aspect, in a case where parcels to be delivered by one delivery person included in the delivery persons are dispersedly stored at a plurality of storage locations, the control unit may set a priority degree of a given berth for the one delivery person to be higher as a total value of distances from the storage locations for the parcels to be delivered by the one delivery person to the given berth is smaller when setting a priority degree of each of the berths for the one delivery person.

In the information processing device according to the above aspect, in a case where parcels to be delivered by one delivery person included in the delivery persons are dispersedly stored at a plurality of storage locations, the control unit may set a priority degree of a given berth for the one delivery person to be higher as a sum of values is smaller when setting a priority degree of each of the berths for the delivery person, each of the values being obtained by multiplying a distance from one location included in the storage locations for the parcels to be delivered by the delivery person to the given berth by a parcel amount of the one or more parcels that are stored at the one location.

In the information processing device according to the above aspect, the control unit may further correct the first work time slot for the first delivery person when none of the berths is allocated to the first delivery person even if the allocation process is executed a predetermined number of times.

According to an embodiment of the present disclosure, the technology of allocating a berth in advance is improved.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram illustrating a schematic configuration of a system according to an embodiment of the present disclosure;

FIG. 2 is a block diagram illustrating a schematic configuration of a terminal device;

FIG. 3 is a block diagram illustrating a schematic configuration of an information processing device;

FIG. 4 is a flowchart illustrating operation of the information processing device; and

FIG. 5 is another flowchart illustrating operation of the information processing device.

### DETAILED DESCRIPTION OF EMBODIMENTS

An embodiment of the present disclosure will be described below.

### Overview of Embodiment

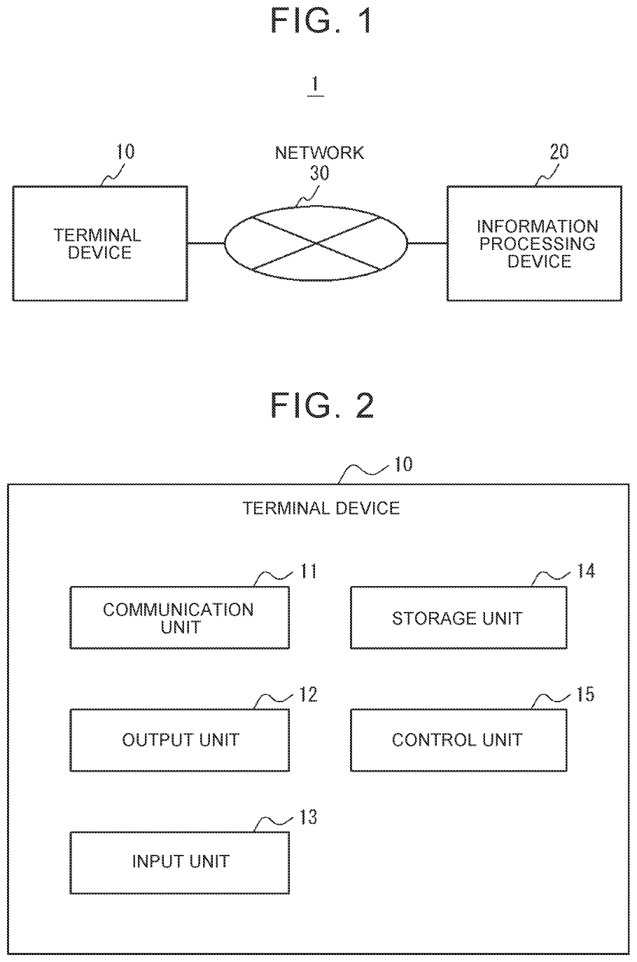

An overview of a system 1 according to an embodiment of the present disclosure will be described with reference to FIG. 1. The system 1 includes a plurality of terminal devices 10 and an information processing device 20. The terminal devices 10 and the information processing device 20 are communicably connected to a network 30 including the Internet, a mobile communication network, etc., for example.

The terminal devices 10 are each a computer such as a personal computer (PC), a smartphone, or a tablet terminal, for example. In the present embodiment, the terminal devices 10 are each used by a delivery person that performs the work of loading parcels, such as a truck driver, for example. The terminal devices 10 may each be a computer mounted on a vehicle such as a truck.

The information processing device 20 is a computer such as a server device, for example. The information processing device 20 can communicate with the terminal devices 10 via the network 30.

First, an overview of the present embodiment will be described, and the details thereof will be discussed later. The information processing device 20 sets the priority degree of each berth for each delivery person based on information (hereinafter also referred to as “first information”) that indicates the position of a storage location in a warehouse for parcels to be delivered by the delivery person and information (hereinafter also referred to as “second information”) that indicates the position of each berth in the warehouse. Next, the information processing device 20 specifies a work time slot (hereinafter also referred to as a “first work time slot”) in which a delivery person (hereinafter also referred to as a “first delivery person”) to whom no berth has been allocated uses a berth. After that, the information processing device 20 executes a process (hereinafter also referred to as an “allocation process”) including: selecting a berth (hereinafter also referred to as a “first berth”) as a candidate to be allocated to the first delivery person, from among a plurality of berths, based on the priority degree of each berth set for the first delivery person; determining whether a condition that a different delivery person (hereinafter also referred to as a “second delivery person”) has already been allocated to the first berth and a work time slot for the first delivery person and a work time slot (hereinafter also referred to as a “second work time slot”) for the second delivery person at least partially overlap each other is met; allocating the first berth to the first delivery person when it is determined that the condition is not met; making a comparison between the priority degree (hereinafter also referred to as a “first priority degree”) of the first berth set for the first delivery person and the priority degree (hereinafter also referred to as a “second priority degree”) of the first berth set for the second delivery person when it is determined that the condition is met; and canceling the allocation of the first berth to the second delivery person and allocating the first berth to the first delivery person when it is determined that the first priority degree is higher than the second priority degree. The information processing device 20 repeatedly executes the allocation process while changing the first berth as a candidate to be allocated to the first delivery person until a berth is allocated to the first delivery person.

In this manner, according to the present embodiment, the information processing device 20 allocates a berth to the first delivery person according to the priority degree based on the position of the storage location and the position of the berth. Therefore, appropriate berths may be allocated to the first delivery person and the second delivery person, even when a berth desired to be allocated to the first delivery person has already been allocated to the second delivery person, for example. Thus, according to the present embodiment, the technology of allocating a berth in advance is improved by possibly reducing the probability that the work of loading parcels due to the positional relationship between a berth allocated to a delivery person and the storage location for parcels to be delivered in a warehouse is hindered.

Next, the components of the system 1 will be described in detail.

### Configuration of Terminal Device

As illustrated in FIG. 2, the terminal device 10 includes a communication unit 11, an output unit 12, an input unit 13, a storage unit 14, and a control unit 15.

The communication unit 11 includes one or more communication interfaces connected to the network 30. The communication interface supports mobile communication standards such as, but not limited to, 4^{th} generation (4G) and 5^{th} generation (5G), for example. In the present embodiment, the terminal device 10 communicates with the information processing device 20 via the communication unit 11 and the network 30.

The output unit 12 includes one or more output devices that output information. The output device may be, but is not limited to, a display that outputs information as video, a speaker that outputs information as audio, etc., for example. The output unit 12 may include an interface for connecting an external output device.

The input unit 13 includes one or more input devices that detect an input operation by a user. The input device may be, but is not limited to, a physical key, a capacitive key, a mouse, a touch panel, a touch screen integrated with the display of the output unit 12, a microphone, etc., for example. The input unit 13 may include an interface for connecting an external input device.

The storage unit 14 includes one or more memories. The memory may be, but is not limited to, a semiconductor memory, a magnetic memory, an optical memory, etc., for example. The memory included in the storage unit 14 may function as a main storage device, an auxiliary storage device, or a cache memory, for example. The storage unit 14 stores any information that is used for operation of the terminal device 10. For example, the storage unit 14 may store a system program, an application program, embedded software, etc. The information stored in the storage unit 14 may be updated with information acquired from the network 30 via the communication unit 11, for example.

The control unit 15 includes one or more processors, one or more programmable circuits, one or more dedicated circuits, or a combination of these. The processor may be, but is not limited to, a general-purpose processor such as a central processing unit (CPU) or a graphics processing unit (GPU), or a dedicated processor specialized for a specific process, for example. The programmable circuit may be, but is not limited to, a field-programmable gate array (FPGA), for example. The dedicated circuit may be, but is not limited to, an application specific integrated circuit (ASIC), for example. The control unit 15 controls operation of the entire terminal device 10.

### Configuration of Information Processing Device

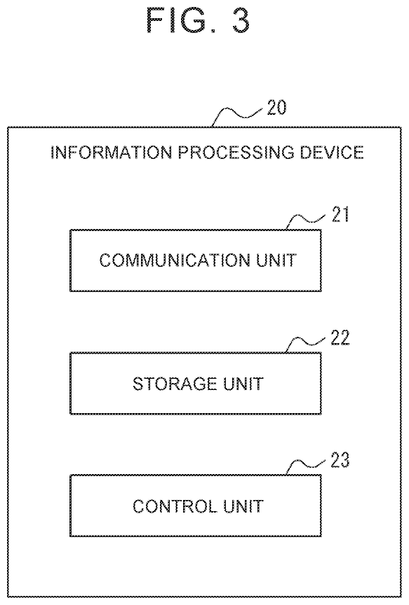

As illustrated in FIG. 3, the information processing device 20 includes a communication unit 21, a storage unit 22, and a control unit 23.

The communication unit 21 includes one or more communication interfaces connected to the network 30. The communication interface supports communication standards such as, but not limited to, a mobile communication standard, a wired local area network (LAN) standard, and a wireless LAN standard, for example, and may support any communication standard. In the present embodiment, the information processing device 20 communicates with the terminal devices 10 via the communication unit 21 and the network 30.

The storage unit 22 includes one or more memories. The memory included in the storage unit 22 may function as a main storage device, an auxiliary storage device, or a cache memory, for example. The storage unit 22 stores any information that is used for operation of the information processing device 20. For example, the storage unit 22 may store a system program, an application program, embedded software, a database, etc. The information stored in the storage unit 22 may be updated with information acquired from the network 30 via the communication unit 21, for example.

The control unit 23 includes one or more processors, one or more programmable circuits, one or more dedicated circuits, or a combination of these. The processor may be, but is not limited to, a general-purpose processor such as a central processing unit (CPU) or a graphics processing unit (GPU), or a dedicated processor specialized for a specific process, for example. The programmable circuit may be, but is not limited to, a field-programmable gate array (FPGA), for example. The dedicated circuit may be, but is not limited to, an application specific integrated circuit (ASIC), for example. The control unit 23 controls operation of the entire information processing device 20.

### Operation Flow of Information Processing Device

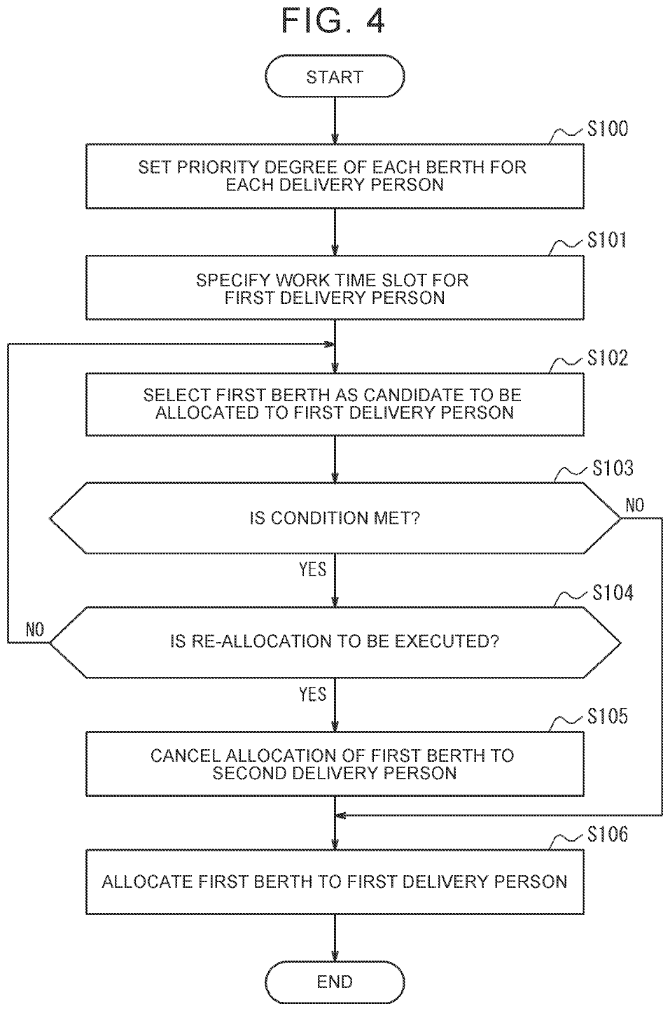

Operation of the information processing device 20 according to the present embodiment will be described with reference to FIG. 4.

Step S100: The control unit 23 of the information processing device 20 sets the priority degree of each berth for each delivery person based on first information and second information stored in the storage unit 22 of the information processing device 20. The priority degree of each berth may be different among delivery persons.

The “first information” is information that indicates the position of the storage location in the warehouse for parcels to be delivered by each delivery person. The “second information” is information that indicates the position of each berth in the warehouse. The first information and the second information may be stored in advance in the storage unit 22, or may be input to the information processing device 20 by an operator, for example.

Specifically, the control unit 23 may set the priority degree of a berth for a certain delivery person to be higher as the distance from the storage location for parcels to be delivered by the delivery person to the berth is shorter. Alternatively, when parcels to be delivered by a certain delivery person are dispersedly stored at a plurality of storage locations, the control unit 23 may set the priority degree of a berth for the delivery person to be higher as the total value of the distances from the storage locations for the parcels to be delivered by the delivery person to the berth is smaller.

Alternatively, the control unit 23 may set the priority degree of each berth for each delivery person based on the first information, the second information, and third information stored in the storage unit 22. The “third information” is information that indicates the parcel amount of parcels to be delivered by the delivery person. The third information may be acquired by any method and stored in the storage unit 22. For example, a worker that transports parcels that have arrived at a warehouse to a storage location may input information on the parcel amount of the parcels and on a delivery person to his/her own handy terminal, and the information may be transmitted from the handy terminal to the information processing device 20. The “parcel amount” may be, but is not limited to, the number of parcels, for example, and may be any index that indicates the amount of parcels such as the weight or the size of parcels, for example.

Specifically, when parcels to be delivered by a certain delivery person are dispersedly stored at a plurality of storage locations, the control unit 23 may set the priority degree of a berth for the delivery person to be higher as the distance from a storage location at which the largest parcel amount of parcels is stored, among the storage locations, to the berth is shorter. Alternatively, when parcels to be delivered by a certain delivery person are dispersedly stored at a plurality of storage locations, the control unit 23 may set the priority degree of a berth for the delivery person to be higher as the total value of values obtained by multiplying the distance from each storage location for the parcels to be delivered by the delivery person to the berth by the corresponding parcel amount of parcels stored at the storage location is smaller.

Step S101: The control unit 23 specifies a work time slot in which a first delivery person to whom no berth has been allocated uses a berth.

Specifically, the control unit 23 specifies a work time slot in which the first delivery person uses a berth using the work time slot for each delivery person stored in the storage unit 22. The first delivery person is a delivery person to whom no berth has been allocated based on whether a berth has been allocated to the work time slot for each delivery person in allocation information on each berth stored in the storage unit 22. The work time slot for each delivery person can be stored in the storage unit 22 by any method. For example, the storage unit 22 may receive the work time slot for each delivery person from the terminal device 10 that the storage unit 22 can communicate with via the communication unit 21, and store the work time slot for each delivery person. Alternatively, the control unit 23 may 23 may receive positional information on each delivery person from each terminal device 10 at all times, and cause the storage unit 22 to store a work time slot calculated based on the distance from the position of the delivery person to the berth. The work time slot for each delivery person stored in the storage unit 22 and the allocation information on each berth stored in the storage unit 22 may be updated by newly receiving information that indicates the work time slot for the delivery person from each terminal device 10, re-allocating a berth as discussed later, etc., for example.

The “work time slot” is information that indicates at least a work start time and a work end time. For example, the work time slot may be constituted from a work start time and a time required for the work, but is not limited thereto, and may include any information about the work time slot.

The “allocation information on each berth” is a schedule table for each berth. For example, the allocation information on each berth may include schedule information about use of a certain berth by a delivery person in a specific time slot, but is not limited thereto, and may include any information about each berth.

Step S102: The control unit 23 selects a first berth as a candidate to be allocated to a first delivery person, from among the berths, based on the priority degree of each berth set for the first delivery person.

Specifically, the control unit 23 selects a berth with the highest priority degree set in step S100 for the first delivery person, from among the berths, as a first berth.

Step S103: The control unit 23 determines whether a condition that a second delivery person has already been allocated to the first berth selected in step S102 and the work time slot for the first delivery person and the work time slot for the second delivery person at least partially overlap each other is met, using the allocation information on each berth stored in the storage unit 22. When it is determined that the condition is met (step S103: Yes), the process proceeds to step S104. When it is determined that the condition is not met (step S103: No), the process proceeds to step S106. In the second or subsequent execution of step S102, the control unit 23 selects, as a first berth, a berth with the highest priority degree set in step S100 for the first delivery person, from among the berths excluding those which have been selected as a first berth in the preceding or earlier execution of step S102. Thus, the berth selected as a first berth in step S102 is changed each time the process in step S102 is executed.

Step S104: When it is determined that the condition in step S103 is met (step S103: Yes), the control unit 23 determines whether to cancel the allocation of the first berth to the second delivery person and allocate the first berth to the first delivery person (hereinafter referred to as “re-allocation”). When it is determined to execute re-allocation (step S104: Yes), the process proceeds to step S105. When it is determined not to execute re-allocation (step S104: No), on the other hand, the process returns to step S102.

Any method can be used to determine whether to execute re-allocation. For example, the control unit 23 makes a comparison between a first priority degree that is the priority degree of the first berth set for the first delivery person and a second priority degree that is the priority degree of the first berth set for the second delivery person. When it is determined that the first priority degree is higher than the second priority degree, the control unit 23 may determine to execute re-allocation. When it is determined that the first priority degree is equal to or less than the second priority degree, on the other hand, the control unit 23 may determine not to execute re-allocation.

When it is determined that the first priority degree is equal to the second priority degree, the control unit 23 may make a comparison between a first parcel amount that is the parcel amount of parcels to be delivered by the first delivery person and a second parcel amount that is the parcel amount of parcels to be delivered by the second delivery person using third information. When it is determined that the first parcel amount is larger than the second parcel amount, the control unit 23 may determine to execute re-allocation. When it is determined that the first parcel amount is equal to or less than the second parcel amount, on the other hand, the control unit 23 may determine not to execute re-allocation.

Step S105: When it is determined in step S104 to execute re-allocation (step S104: Yes), the control unit 23 cancels the allocation of the first berth to the second delivery person.

Step S106: After step S105 or when it is determined in step S103 that the condition is not met (step S103: No), the control unit 23 allocates the first berth to the first delivery person.

As discussed above, the control unit 23 repeatedly executes an allocation process (corresponding to steps S102 to S106 in FIG. 4) while changing the first berth as a candidate to be allocated to the first delivery person until a berth is allocated to the first delivery person. When there is another delivery person to whom no berth has been allocated after a berth is allocated to the first delivery person, the control unit 23 may continue the process from step S101 with the other delivery person determined as a new first delivery person.

As discussed above, the information processing device 20 according to the present embodiment sets the priority degree of each berth for each delivery person based on first information and second information, the first information indicating the position of a storage location in the warehouse for parcels to be delivered by each delivery person, and the second information indicating the position of each berth in the warehouse. Next, the information processing device 20 specifies a work time slot in which a first delivery person to whom no berth has been allocated uses a berth. After that, the information processing device 20 executes an allocation process including: selecting a first berth as a candidate to be allocated to the first delivery person, from among the berths, based on the priority degree of each berth set for the first delivery person; determining whether a condition that a second delivery person has already been allocated to the first berth and a work time slot for the first delivery person and a work time slot for the second delivery person at least partially overlap each other is met; allocating the first berth to the first delivery person when it is determined that the condition is not met; making a comparison between a first priority degree and a second priority degree when it is determined that the condition is met, the first priority degree being the priority degree of the first berth set for the first delivery person, and the second priority degree being the priority degree of the first berth set for the second delivery person; and canceling the allocation of the first berth to the second delivery person and allocating the first berth to the first delivery person when it is determined that the first priority degree is higher than the second priority degree. The information processing device 20 repeatedly executes the allocation process while changing the first berth as a candidate to be allocated to the first delivery person until a berth is allocated to the first delivery person.

With such a configuration, the information processing device 20 allocates a berth to the first delivery person according to the priority degree based on the position of the storage location and the position of the berth. Therefore, appropriate berths may be allocated to the first delivery person and the second delivery person, even when a berth desired to be allocated to the first delivery person has already been allocated to the second delivery person, for example. Thus, according to the present embodiment, the technology of allocating a berth in advance is improved by possibly reducing the probability that the work of loading parcels is hindered, depending on the positional relationship between a berth allocated to a delivery person and the storage location for parcels to be delivered in a warehouse.

While the present disclosure has been described based on the drawings and the embodiment, it should be noted that a person skilled in the art may make various modifications and alterations thereto based on the present disclosure. Thus, these modifications and alterations are within the scope of the present disclosure. For example, the functions etc. included in the components, the steps, etc. can be re-arranged in a manner that they are not logically inconsistent, and a plurality of components, steps, etc. can be combined into one or can be divided.

For example, in the embodiment discussed above, the configuration and operation of the information processing device 20 may be distributed among a plurality of computers that can communicate with each other. In addition, an embodiment in which some or all of the constituent elements of the information processing device 20 are provided in the terminal device 10 is also possible, for example. For example, the terminal device 10 mounted on a vehicle may include some or all of the constituent elements of the information processing device 20.

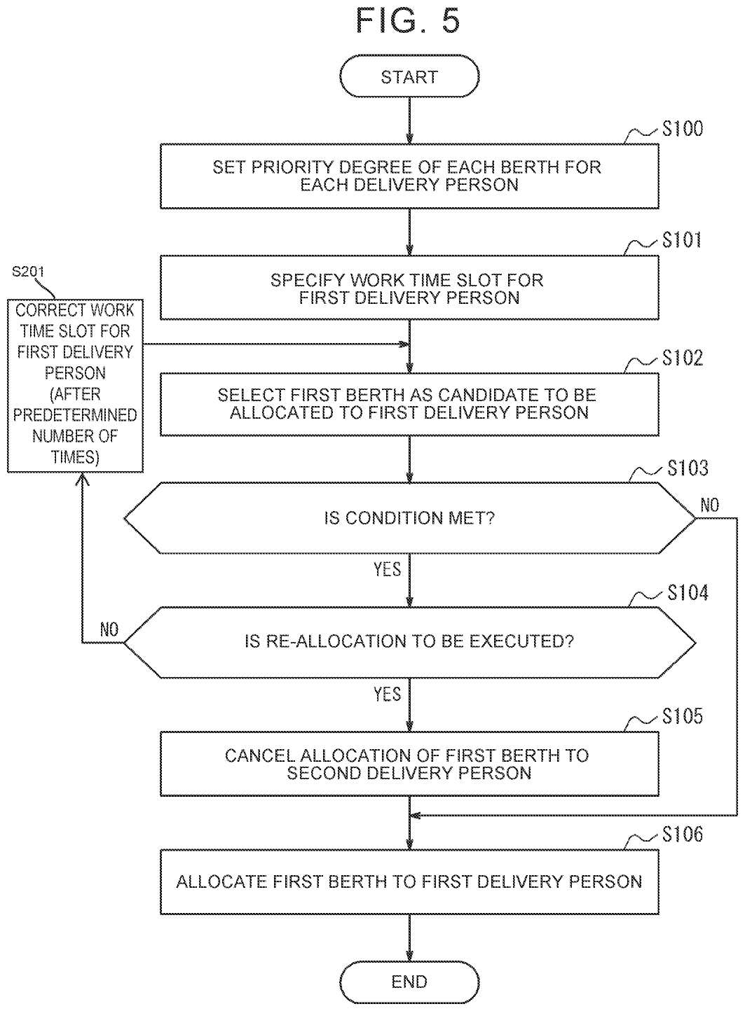

In the embodiment discussed above, in addition, when the control unit 23 of the information processing device 20 fails to allocate a berth to the first delivery person even if the allocation process is executed a predetermined number of times, the control unit 23 may correct the work time slot for the first delivery person in step S201 as shown in FIG. 5, for example. Specifically, when the control unit 23 fails to allocate a berth to the first delivery person even if the allocation process is performed for all the berths, the control unit 23 corrects the work time slot for the first delivery person to a predetermined time (e.g. 5 minutes) earlier or later, returns to step S102, and executes the allocation process for the corrected work time slot, for example. In this case, when it is determined in step S103 that the condition is met (step S103: Yes), the control unit 23 may determine not to execute re-allocation in the following step S104. That is, when the control unit 23 determines in step S103 that the condition that the second delivery person is already allocated to the first berth selected in step S102 and the work time slot for the first delivery person and the work time slot for the second delivery person at least partially overlap each other is met, the process returns to step S102. As in the embodiment discussed above, in the second or subsequent execution of step S102, the control unit 23 selects, as a first berth, a berth with the highest priority degree set in step S100 for the first delivery person, from among the berths excluding those which have been selected as a first berth in the preceding or earlier execution of step S102. The control unit 23 repeatedly executes the allocation process while changing the first berth, when there is a first berth as a candidate to be allocated, until a berth is allocated to the first delivery person, and further corrects the work time slot and repeatedly executes the allocation process when there is no more first berth.

The “predetermined number of times” mentioned above is equal to the number of berths that are present in the warehouse, for example, but is not limited thereto, and may be any number of times.

The work time slot may be corrected to a certain time earlier or later. The certain time may be any number of seconds, minutes, or hours, or may be a combination of these.

In the embodiment discussed above, in addition, the control unit 23 of the information processing device 20 may transmit the result of executing the allocation process to each of the terminal device 10 of the first delivery person and the terminal device 10 of the second delivery person, for example. The result of executing the allocation process includes information on the berth allocated to each delivery person, for example, but may further include the position of the storage location for parcels, or information associated with work of each delivery person in the warehouse such as work time slot, besides information on the berth allocated to each delivery person, for example. The result of executing the allocation process may not be transmitted to a delivery person that is not affected by the result of executing the allocation process, such as a delivery person whose allocated berth is not changed, for example, even if the allocation process is executed.

Some of the embodiment of the present disclosure will be described below by way of example. It should be noted, however, that the embodiment of the present disclosure is not limited thereto.

### Appendix 1

A method executed by an information processing device that determines a berth to be allocated to a delivery person from among a plurality of berths provided in a warehouse, the method including: setting a priority degree of each berth for each delivery person based on first information and second information, the first information indicating a position of a storage location in the warehouse for parcels to be delivered by each delivery person, and the second information indicating a position of each berth in the warehouse; specifying a work time slot in which a first delivery person to whom no berth has been allocated uses a berth;

and executing an allocation process including selecting a first berth as a candidate to be allocated to the first delivery person, from among the berths, based on a priority degree of each berth set for the first delivery person, determining whether a condition that a second delivery person has already been allocated to the first berth and a work time slot for the first delivery person and a work time slot for the second delivery person at least partially overlap each other is met, allocating the first berth to the first delivery person when it is determined that the condition is not met, making a comparison between a first priority degree and a second priority degree when it is determined that the condition is met, the first priority degree being a priority degree of the first berth set for the first delivery person, and the second priority degree being a priority degree of the first berth set for the second delivery person, and canceling allocation of the first berth to the second delivery person and allocating the first berth to the first delivery person when it is determined that the first priority degree is higher than the second priority degree, in which the information processing device repeatedly executes the allocation process while changing the first berth as a candidate to be allocated to the first delivery person until a berth is allocated to the first delivery person.

### Appendix 2

The method according to appendix 1, in which:
the information processing device sets a priority degree of each berth for each delivery person based on the first information, the second information, and third information that indicates a parcel amount of parcels to be delivered by the delivery person; and the allocation process further includes making a comparison between a first parcel amount and a second parcel amount when it is determined that the first priority degree is equal to the second priority degree, the first parcel amount being a parcel amount of parcels to be delivered by the first delivery person, and the second parcel amount being a parcel amount of parcels to be delivered by the second delivery person, and canceling the allocation of the first berth to the second delivery person and allocating the first berth to the first delivery person when it is determined that the first parcel amount is larger than the second parcel amount.

### Appendix 3

The method according to appendix 2, in which when parcels to be delivered by a certain delivery person are dispersedly stored at a plurality of storage locations, the information processing device sets a priority degree of a berth for the delivery person to be higher as a distance from a storage location at which a largest parcel amount of parcels is stored, among the storage locations, to the berth is shorter when setting a priority degree of each berth for the delivery person.

### Appendix 4

The method according to any one of appendices 1 to 3, in which when parcels to be delivered by a certain delivery person are dispersedly stored at a plurality of storage locations, the information processing device sets a priority degree of a berth for the delivery person to be higher as a total value of distances from the storage locations for the parcels to be delivered by the delivery person to the berth is smaller when setting a priority degree of each berth for the delivery person.

### Appendix 5

The method according to any one of appendices 2 to 4, in which when parcels to be delivered by a certain delivery person are dispersedly stored at a plurality of storage locations, the information processing device sets a priority degree of a berth for the delivery person to be higher as a sum of values obtained by multiplying a distance from each storage location for the parcels to be delivered by the delivery person to the berth by a parcel amount of the parcels stored at the storage location is smaller when setting a priority degree of each berth for the delivery person.

### Appendix 6

The method according to any one of appendices 1 to 5, further including correcting a work time slot for the first delivery person when no berth is allocated to the first delivery person even if the allocation process is executed a predetermined number of times.

### Appendix 7

The method according to any one of appendices 1 to 6, further including transmitting a result of executing the allocation process to a terminal device of the first delivery person and a terminal device of the second delivery person.

### Appendix 8

A program causing an information processing device that determines a berth to be allocated to a delivery person from among a plurality of berths provided in a warehouse to execute processes including: setting a priority degree of each berth for each delivery person based on first information and second information, the first information indicating a position of a storage location in the warehouse for parcels to be delivered by each delivery person, and the second information indicating a position of each berth in the warehouse; specifying a work time slot in which a first delivery person to whom no berth has been allocated uses a berth; and executing an allocation process including selecting a first berth as a candidate to be allocated to the first delivery person, from among the berths, based on a priority degree of each berth set for the first delivery person, determining whether a condition that a second delivery person has already been allocated to the first berth and a work time slot for the first delivery person and a work time slot for the second delivery person at least partially overlap each other is met, allocating the first berth to the first delivery person when it is determined that the condition is not met, making a comparison between a first priority degree and a second priority degree when it is determined that the condition is met, the first priority degree being a priority degree of the first berth set for the first delivery person, and the second priority degree being a priority degree of the first berth set for the second delivery person, and canceling allocation of the first berth to the second delivery person and allocating the first berth to the first delivery person when it is determined that the first priority degree is higher than the second priority degree, in which the information processing device repeatedly executes the allocation process while changing the first berth as a candidate to be allocated to the first delivery person until a berth is allocated to the first delivery person.

### Appendix 9

The program according to appendix 8, in which the information processing device sets a priority degree of each berth for each delivery person based on the first information, the second information, and third information that indicates a parcel amount of parcels to be delivered by the delivery person; and the allocation process further includes making a comparison between a first parcel amount and a second parcel amount when it is determined that the first priority degree is equal to the second priority degree, the first parcel amount being a parcel amount of parcels to be delivered by the first delivery person, and the second parcel amount being a parcel amount of parcels to be delivered by the second delivery person, and canceling the allocation of the first berth to the second delivery person and allocating the first berth to the first delivery person when it is determined that the first parcel amount is larger than the second parcel amount.

### Appendix 10

The program according to appendix 9, in which when parcels to be delivered by a certain delivery person are dispersedly stored at a plurality of storage locations, the information processing device sets a priority degree of a berth for the delivery person to be higher as a distance from a storage location at which a largest parcel amount of parcels is stored, among the storage locations, to the berth is shorter when setting a priority degree of each berth for the delivery person.

### Appendix 11

The program according to any one of appendices 8 to 10, in which when parcels to be delivered by a certain delivery person are dispersedly stored at a plurality of storage locations, the information processing device sets a priority degree of a berth for the delivery person to be higher as a total value of distances from the storage locations for the parcels to be delivered by the delivery person to the berth is smaller when setting a priority degree of each berth for the delivery person.

### Appendix 12

The program according to any one of appendices 9 to 11, in which when parcels to be delivered by a certain delivery person are dispersedly stored at a plurality of storage locations, the information processing device sets a priority degree of a berth for the delivery person to be higher as a sum of values obtained by multiplying a distance from each storage location for the parcels to be delivered by the delivery person to the berth by a parcel amount of the parcels stored at the storage location is smaller when setting a priority degree of each berth for the delivery person.

### Appendix 13

The program according to any one of appendices 8 to 12, in which the information processing device is further caused to correct a work time slot for the first delivery person when no berth is allocated to the first delivery person even if the allocation process is executed a predetermined number of times.

### Appendix 14

The program according to any one of appendices 8 to 12, in which the information processing device is further caused to transmit a result of executing the allocation process to a terminal device of the first delivery person and a terminal device of the second delivery person.

### Appendix 15

An information processing device that determines a berth to be allocated to a delivery person from among a plurality of berths provided in a warehouse, including a control unit configured to: set a priority degree of each berth for each delivery person based on first information and second information, the first information indicating a position of a storage location in the warehouse for parcels to be delivered by each delivery person, and the second information indicating a position of each berth in the warehouse; specify a work time slot in which a first delivery person to whom no berth has been allocated uses a berth; and execute an allocation process including selecting a first berth as a candidate to be allocated to the first delivery person, from among the berths, based on a priority degree of each berth set for the first delivery person, determining whether a condition that a second delivery person has already been allocated to the first berth and a work time slot for the first delivery person and a work time slot for the second delivery person at least partially overlap each other is met, allocating the first berth to the first delivery person when it is determined that the condition is not met, making a comparison between a first priority degree and a second priority degree when it is determined that the condition is met, the first priority degree being a priority degree of the first berth set for the first delivery person, and the second priority degree being a priority degree of the first berth set for the second delivery person, canceling allocation of the first berth to the second delivery person and allocating the first berth to the first delivery person when it is determined that the first priority degree is higher than the second priority degree, and repeatedly executing the allocation process while changing the first berth as a candidate to be allocated to the first delivery person until a berth is allocated to the first delivery person.

### Appendix 16

The information processing device according to appendix 15, in which: the control unit sets a priority degree of each berth for each delivery person based on the first information, the second information, and third information that indicates a parcel amount of parcels to be delivered by the delivery person; and the allocation process further includes making a comparison between a first parcel amount and a second parcel amount when it is determined that the first priority degree is equal to the second priority degree, the first parcel amount being a parcel amount of parcels to be delivered by the first delivery person, and the second parcel amount being a parcel amount of parcels to be delivered by the second delivery person, and canceling the allocation of the first berth to the second delivery person and allocating the first berth to the first delivery person when it is determined that the first parcel amount is larger than the second parcel amount.

### Appendix 17

The information processing device according to appendix 16, in which when parcels to be delivered by a certain delivery person are dispersedly stored at a plurality of storage locations, the control unit sets a priority degree of a berth for the delivery person to be higher as a distance from a storage location at which a largest parcel amount of parcels is stored, among the storage locations, to the berth is shorter when setting a priority degree of each berth for the delivery person.

### Appendix 18

The information processing apparatus according to any one of appendices 15 to 17, in which when parcels to be delivered by a certain delivery person are dispersedly stored at a plurality of storage locations, the control unit sets a priority degree of a berth for the delivery person to be higher as a total value of distances from the storage locations for the parcels to be delivered by the delivery person to the berth is smaller when setting a priority degree of each berth for the delivery person.

### Appendix 19

The information processing apparatus according to any one of appendices 16 to 18, in which when parcels to be delivered by a certain delivery person are dispersedly stored at a plurality of storage locations, the control unit sets a priority degree of a berth for the delivery person to be higher as a total value of values obtained by multiplying a distance from each storage location for the parcels to be delivered by the delivery person to the berth by a parcel amount of the parcels stored at the storage location is smaller when setting a priority degree of each berth for the delivery person.

### Appendix 20

The information processing apparatus according to any one of appendices 15 to 19, in which the control unit further corrects a work time slot for the first delivery person when no berth is allocated to the first delivery person even if the allocation process is executed a predetermined number of times.

What is claimed is:

1. A method executed by an information processing device that determines a berth to be allocated to a delivery person from among a plurality of berths provided in a warehouse, the method comprising:
setting priority degrees of the berths for each of delivery persons, each of the priority degrees of the berths being set based on first information and second information, the first information indicating a position of a storage location in the warehouse for each of one or more parcels to be delivered by a corresponding one of the delivery persons, and the second information indicating a position of each of the berths in the warehouse;
specifying a first work time slot in which a first delivery person to whom none of the berths has been allocated uses any one of the berths, the first delivery person being included in the delivery persons; and
executing an allocation process including
selecting a first berth as a candidate to be allocated to the first delivery person, from among the berths, based on a priority degree of each of the berths set for the first delivery person,
determining whether a condition that a second delivery person has already been allocated to the first berth and the first work time slot for the first delivery person and a second work time slot for the second delivery person at least partially overlap each other is met, the second delivery person being included in the delivery persons,
allocating the first berth to the first delivery person when it is determined that the condition is not met,
making a comparison between a first priority degree and a second priority degree when it is determined that the condition is met, the first priority degree being a priority degree of the first berth set for the first delivery person, and the second priority degree being a priority degree of the first berth set for the second delivery person, and
canceling allocation of the first berth to the second delivery person and allocating the first berth to the first delivery person when it is determined that the first priority degree is higher than the second priority degree,
wherein the information processing device repeatedly executes the allocation process while changing the first berth as a candidate to be allocated to the first delivery person until one of the berths is allocated to the first delivery person.

2. The method according to claim 1, wherein:
the information processing device sets the priority degrees of the berths for each of the delivery persons based on the first information, the second information, and third information, the third information being information that indicates a parcel amount of the one or more parcels to be delivered by the corresponding one of the delivery persons; and
the allocation process further includes
making a comparison between a first parcel amount and a second parcel amount when it is determined that the first priority degree is equal to the second priority degree, the first parcel amount being a parcel amount of one or more parcels to be delivered by the first delivery person, and the second parcel amount being a parcel amount of one or more parcels to be delivered by the second delivery person, and
canceling the allocation of the first berth to the second delivery person and allocating the first berth to the first delivery person when it is determined that the first parcel amount is larger than the second parcel amount.

3. The method according to claim 2, wherein in a case where parcels to be delivered by one delivery person included in the delivery persons are dispersedly stored at a plurality of storage locations, the information processing device sets a priority degree of a given berth for the one delivery person to be higher as a distance from a storage location at which a largest parcel amount of parcels is stored, among the storage locations, to the given berth is shorter when setting a priority degree of each of the berths for the one delivery person.

4. The method according to claim 1, wherein in a case where parcels to be delivered by one delivery person included in the delivery persons are dispersedly stored at a plurality of storage locations, the information processing device sets a priority degree of a given berth for the one delivery person to be higher as a total value of distances from the storage locations for the parcels to be delivered by the one delivery person to the given berth is smaller when setting a priority degree of each of the berths for the one delivery person.

5. The method according to claim 2, wherein in a case where parcels to be delivered by one delivery person included in the delivery persons are stored dispersedly at a plurality of storage locations, the information processing device sets a priority degree of a given berth for the one delivery person to be higher as a sum of values is smaller when setting a priority degree of each of the berths for the one delivery person, each of the values being obtained by multiplying a distance from one location included in the storage locations for the parcels to be delivered by the one delivery person to the given berth by a parcel amount of the one or more parcels that are stored at the one location.

6. The method according to claim 1, further comprising correcting the first work time slot for the first delivery person when none of the berths is allocated to the first delivery person even if the allocation process is executed a predetermined number of times.

7. The method according to claim 1, further comprising transmitting a result of executing the allocation process to a terminal device of the first delivery person and a terminal device of the second delivery person.

8. A non-transitory computer-readable medium storing a program causing an information processing device that determines a berth to be allocated to a delivery person from among a plurality of berths provided in a warehouse to execute processes comprising:
setting priority degrees of the berths for each of delivery persons, each of the priority degrees of the berths being set based on first information and second information, the first information indicating a position of a storage location in the warehouse for each of one or more parcels to be delivered by a corresponding one of the delivery persons, and the second information indicating a position of each of the berths in the warehouse;
specifying a first work time slot in which a first delivery person to whom none of the berths has been allocated uses any one of the berths, the first delivery person included in the delivery persons; and
executing an allocation process including
selecting a first berth as a candidate to be allocated to the first delivery person, from among the berths, based on a priority degree of each of the berths set for the first delivery person,
determining whether a condition that a second delivery person has already been allocated to the first berth and the first work time slot for the first delivery person and a second work time slot for the second delivery person at least partially overlap each other is met, the second delivery person being included in the delivery persons,
allocating the first berth to the first delivery person when it is determined that the condition is not met,
making a comparison between a first priority degree and a second priority degree when it is determined that the condition is met, the first priority degree being a priority degree of the first berth set for the first delivery person, and the second priority degree being a priority degree of the first berth set for the second delivery person, and
canceling allocation of the first berth to the second delivery person and allocating the first berth to the first delivery person when it is determined that the first priority degree is higher than the second priority degree,
wherein the information processing device repeatedly executes the allocation process while changing the first berth as a candidate to be allocated to the first delivery person until one of the berths is allocated to the first delivery person.

9. The non-transitory computer-readable medium according to claim 8, wherein:
the information processing device sets the priority degrees of the berths for each of the delivery persons based on the first information, the second information, and third information, the third information being information that indicates a parcel amount of the one or more parcels to be delivered by the corresponding one of the delivery persons; and
the allocation process further includes
making a comparison between a first parcel amount and a second parcel amount when it is determined that the first priority degree is equal to the second priority degree, the first parcel amount being a parcel amount of one or more parcels to be delivered by the first delivery person, and the second parcel amount being a parcel amount of one or more parcels to be delivered by the second delivery person, and
canceling the allocation of the first berth to the second delivery person and allocating the first berth to the first delivery person when it is determined that the first parcel amount is larger than the second parcel amount.

10. The non-transitory computer-readable medium according to claim 9, wherein in a case where parcels to be delivered by one delivery person included in the delivery persons are dispersedly stored at a plurality of storage locations, the information processing device sets a priority degree of a given berth for the one delivery person to be higher as a distance from a storage location at which a largest parcel amount of parcels is stored, among the storage locations, to the given berth is shorter when setting a priority degree of each of the berths for the one delivery person.

11. The non-transitory computer-readable medium according to claim 8, wherein in a case where parcels to be delivered by one delivery person included in the delivery persons are dispersedly stored at a plurality of storage locations, the information processing device sets a priority degree of a given berth for the one delivery person to be higher as a total value of distances from the storage locations for the parcels to be delivered by the one delivery person to the given berth is smaller when setting a priority degree of each of the berths for the one delivery person.

12. The non-transitory computer-readable medium according to claim 9, wherein in a case where parcels to be delivered by one delivery person included in the delivery persons are dispersedly stored at a plurality of storage locations, the information processing device sets a priority degree of a given berth for the one delivery person to be higher as a sum of values is smaller when setting a priority degree of each of the berths for the one delivery person, each of the values being obtained by multiplying a distance from one location included in the storage locations for the parcels to be delivered by the one delivery person to the given berth by a parcel amount of the one or more parcels that are stored at the one location.

13. The non-transitory computer-readable medium according to claim 8, wherein the information processing device is further caused to correct the first work time slot for the first delivery person when none of the berths is allocated to the first delivery person even if the allocation process is executed a predetermined number of times.

14. The non-transitory computer-readable medium according to claim 8, wherein the information processing device is further caused to transmit a result of executing the allocation process to a terminal device of the first delivery person and a terminal device of the second delivery person.

15. An information processing device that determines a berth to be allocated to a delivery person from among a plurality of berths provided in a warehouse, comprising a control unit configured to:
set priority degrees of the berths for each of delivery persons, each of the priority degrees of the berths being set based on first information and second information, the first information indicating a position of a storage location in the warehouse for each of one or more parcels to be delivered by a corresponding one of the delivery persons, and the second information indicating a position of each of the berths in the warehouse;
specify a first work time slot in which a first delivery person to whom none of the berths has been allocated uses any one of the berths, the first delivery person being included in the delivery persons; and
execute an allocation process including
selecting a first berth as a candidate to be allocated to the first delivery person, from among the berths, based on a priority degree of each of the berths set for the first delivery person,
determining whether a condition that a second delivery person has already been allocated to the first berth and the first work time slot for the first delivery person and a second work time slot for the second delivery person at least partially overlap each other is met, the second delivery person being included in the delivery persons,
allocating the first berth to the first delivery person when it is determined that the condition is not met,
making a comparison between a first priority degree and a second priority degree when it is determined that the condition is met, the first priority degree being a priority degree of the first berth set for the first delivery person, and the second priority degree being a priority degree of the first berth set for the second delivery person,
canceling allocation of the first berth to the second delivery person and allocating the first berth to the first delivery person when it is determined that the first priority degree is higher than the second priority degree, and
repeatedly executing the allocation process while changing the first berth as a candidate to be allocated to the first delivery person until one of the berths is allocated to the first delivery person.

16. The information processing device according to claim 15, wherein:
the control unit sets the priority degrees of the berths for each of the delivery persons based on the first information, the second information, and third information, the third information being information that indicates a parcel amount of the one or more parcels to be delivered by the corresponding one of the delivery persons; and
the allocation process further includes
making a comparison between a first parcel amount and a second parcel amount when it is determined that the first priority degree is equal to the second priority degree, the first parcel amount being a parcel amount of one or more parcels to be delivered by the first delivery person, and the second parcel amount being a parcel amount of one or more parcels to be delivered by the second delivery person, and
canceling the allocation of the first berth to the second delivery person and allocating the first berth to the first delivery person when it is determined that the first parcel amount is larger than the second parcel amount.

17. The information processing device according to claim 16, wherein in a case where parcels to be delivered by one delivery person included in the delivery persons are dispersedly stored at a plurality of storage locations, the control unit sets a priority degree of a given berth for the one delivery person to be higher as a distance from a storage location at which a largest parcel amount of parcels is stored, among the storage locations, to the given berth is shorter when setting a priority degree of each of the berths for the one delivery person.

18. The information processing device according to claim 15, wherein in a case where parcels to be delivered by one delivery person included in the delivery persons are dispersedly stored at a plurality of storage locations, the control unit sets a priority degree of a given berth for the one delivery person to be higher as a total value of distances from the storage locations for the parcels to be delivered by the one delivery person to the given berth is smaller when setting a priority degree of each of the berths for the one delivery person.

19. The information processing device according to claim 16, wherein in a case where parcels to be delivered by one delivery person included in the delivery persons are dispersedly stored at a plurality of storage locations, the control unit sets a priority degree of a given berth for the one delivery person to be higher as a sum of values is smaller when setting a priority degree of each of the berths for the one delivery person, each of the values being obtained by multiplying a distance from one location included in the storage locations for parcels to be delivered by the one delivery person to the given berth by a parcel amount of the one or more parcels that are stored at the one location.

20. The information processing device according to claim 15, wherein the control unit further corrects the first work time slot for the first delivery person when none of the berths is allocated to the first delivery person even if the allocation process is executed a predetermined number of times.
